(19) United States
(12) Patent Application Publication
(10) Pub. No.: US 2015/0161754 A1
(43) Pub. Date: Jun. 11, 2015

(54) SYSTEM AND METHOD FOR REMOTE GRAPHICS USING NON-PIXEL RENDERING INTERFACES

(71) Applicant: Joel Solomon Isaacson, Rehovot (IL)

(72) Inventor: Joel Solomon Isaacson, Rehovot (IL)

(21) Appl. No.: 14/102,341

(22) Filed: Dec. 10, 2013

(51) Int. Cl. G06T 1/20; G06F 3/14

(52) U.S. Cl. CPC G06T 1/20; G06F 3/1407

(57) ABSTRACT

A system that allows graphics to be displayed on a local device via a communication channel connected to a remote computing device. The graphics are exported via non-pixel rendering APIs.

### CROSS REFERENCE TO OTHER APPLICATIONS

This application claims priority to U.S. Provisional Patent Application No. 61/735,555 entitled REMOTE RENDERING IMPLEMENTATION filed Dec. 11, 2012 which is incorporated herein by reference for all purposes.

### FIELD OF THE INVENTION

This invention generally relates to computerized rendering of graphics and more specifically to a system and method of enabling of remote graphics in systems that have not been specifically designed to enable remote transmission of graphics.

### BACKGROUND

Remote graphics systems have a long history and are widely used. One of the earliest, called the X window system, usually abbreviated X11, was introduced in 1984 and is in common use today. Unlike most earlier display protocols, X11 was designed to separate the graphics stack into two processes that communicate only via IPC (Inter Process Communications). The X11 protocol is designed to be used over a network between different operating systems, machine architectures and a wide array of graphic display hardware. X11's network protocol is based on the original 2-D X11 command primitives and the more recently added OpenGL 3D primitives for high performance 3-D graphics. This allows both 2-D and 3-D operations to be fully accelerated on the X11 display hardware.

The upper layers of the graphics stack comprises the X11 client. The lower layers of the graphics stack comprises the X11 server. The X11 client-server can run physically on one machine or can be split between two separate machines that are in different locations. It is important to note that the client-server relationship in X11 is notationally inverted in relationship to most systems such as Microsoft's Remote Desktop Protocol (RDP).

The X11 client normally comprises of a user application constructed from the API of a GUI widget toolkit. The Graphical User Interface (GUI) widget toolkit is constructed from the X1compri1 protocol library typically called Xlib. Xlib is the X11 client side remote rendering library. The X11 client can therefore be thought of as a tri-layered software stack: App-Toolkit-Xlib.

The X11 server runs on the machine with the actual graphic display hardware. It consists of a higher level hardware independent part which deals with the X11 protocol rendering stream. The lower level of the server deals with the actual displaying of the rendered data on the graphics display.

The X11 protocol was designed for low latency, high speed, local area networks. When used with a high latency, low speed data link, such as a long haul internet link, its performance is very poor. There are a number of solutions to this problem. One notable solution is from NX Technologies which accelerates the use of the X11 protocol over high latency and low speed data links. It tackles the high latency by eliminating most round trip exchanges between the server and client. It also aggressively caches bitmapped data on the server end and addresses the problem of low speed by using data compression to minimize the amount of transmitted data.

Another widely used remote graphics protocol is the Remote Desktop Protocol (RDP), a proprietary protocol developed by Microsoft, which provides users with a graphical interface to another computer. This system provides remote access to more than just graphics. Clients exist for most versions of Microsoft Windows (including WINDOWS® Mobile), Linux, Unix, Mac OS X, Android™, and other modern operating systems.

There are many other examples of proprietary client-server remote desktop software products such as Oracle/Sun Microsystems' Appliance Link Protocol, Citrix's Independent Computing Architecture and Hewlett-Packard's Remote Graphics Software.

All the above remote graphics systems have been carefully designed to allow remote access to graphic applications. There are some systems that can be used to retrofit remote capabilities in systems that have not been specifically designed for remote graphics such as Virtual Network Computing (VNC).

VNC is a graphical desktop sharing system that uses the Remote FrameBuffer (RFB) protocol to remotely control another computer. It sends graphical screen updates over a network from the VNC server to the VNC client.

The VNC protocol is pixel based. This accounts both for its greatest strengths and weaknesses. Since it is pixel based, the interaction with the graphics server can be via a simple mapping to the display framebuffer. This allows simple support for many different systems without the need to provide specific support for the sometimes complex higher level graphical desktop software. VNC server/clients exist for most systems that support graphical operations. However, VNC is often less efficient than solutions that use more compact graphical representations such as X11 or WINDOWS® Remote Desktop Protocol. Those protocols send high level graphical rendering primitives (e.g., “draw circle”), whereas VNC just sends the raw pixel data.

Recent developments in graphical acceleration hardware and the acceptance of a richer user experience have led to new graphical interface systems that abandoned the possibility of network transparency. This is true for Apple's IOS and Google's Android™ graphics subsystems. The next generation of the Unix-Linux graphics stack is migrating from the network-friendly X11 to the non-networked enabled Wayland display server protocol. These new graphic systems allow the re-rendering of full screen graphics at a very high frame rate. Traditionally, X11 programs minimized rendering by doing only partial redraws of graphics for each frame.

There is a general push to cloud computing which centralizes the computational elements and provides services over a network (typically the Internet). Remote graphics is typically done with HTML5. It is unclear whether this model will enable a sufficiently rich graphical interface as users have grown to expect.

Many graphics stacks are designed with the assumption that all the elements of the stack reside on one device. It is sometimes advantageous to distribute the graphics stack between more than one device. In order to distribute the graphic rendering, network communications must be established between pixel rendering elements of the graphic rendering stack residing on different machines. Isaacson (U.S. Patent Application No. 2012/0113091 A1) deals with retrofitting graphics stacks that were not designed for remote operation to work efficiently with the graphics stack split between machines. It also teaches that pixel rendering need not be performed on the server. It also teaches compression techniques.

### SUMMARY OF THE INVENTION

The standard graphics stack of computerized devices normally is visualized as a multilevel stack. Each computational element on the stack exchanges data with the elements directly above and below them. Many graphics stacks are designed with the assumption that all the elements of the stack reside on one device. It is sometimes advantageous to distribute the graphics stack between more than one device. There are multiple ways to distribute the elements between different devices.

There are instances where the graphics stack is linear, i.e., each element on the stack communicates with at most one element, both above and below it. In other instances, the graphics stack could be non-linear, i.e., each element on the stack communicates with possibly many elements, both above and below it.

In order to distribute the graphic rendering, network communications must be established between elements of the stack residing on different machines. This invention deals with retrofitting graphics stacks that were not designed for remote operation to work efficiently with the graphics stack split between machines. It enables communications between remote and local elements of the graphics stack, not only terminal elements as taught in U.S. Patent Application No. 2012/0113091 A1, thereby improving the performance of remote graphics.

### BRIEF DESCRIPTION OF THE DRAWINGS

FIG. 1 is a typical graphics stack for a digital device that is in the prior art.

FIG. 2 is the graphics stack of Android™, an operating system for mobile devices that is in the prior art.

FIG. 3 is a simplified diagram of a system for remote graphics with a distributed graphics stack that is in the prior art.

FIG. 4 is a simplified diagram of a system for remote graphics with a distributed graphics stack that is in the prior art.

FIG. 5 is a simplified diagram of an Android™ system for remote graphics with a distributed graphics stack that is in the prior art.

FIG. 6 is a simplified diagram of a graphic application that uses three graphic toolkits to render the pixels of the application that is in the prior art.

FIG. 7 is a simplified diagram of a graphic application run on the graphical server. Each element in the multiple graphics stacks has been instrumented to communicate with its counterparts on the client (FIG. 8), in accordance with an embodiment of the present invention.

FIG. 8 is a simplified diagram of a graphic application run on the graphical client. Each element in the multiple graphics stacks has been instrumented to communicate with its counterparts on the server (FIG. 7), in accordance with an embodiment of the present invention.

FIG. 9 is a simplified diagram, that is in the prior art, of an application using the standard Android™ GUI to render pixels.

FIG. 10 is a simplified diagram of an application, running on the server, using the standard Android™ GUI to render pixels remotely on the client.

FIG. 11 is a simplified diagram of an application, running on the server, using the standard Android™ GUI to render pixels remotely on the client. The graphics are exported via the interface of a non-pixel rendering elements.

FIG. 12 is a simplified diagram of an application, that is in the prior art, running on the server, using the standard Android™ GUI to render pixels remotely on the client. The graphics are exported via the interface of pixel rendering elements.

FIG. 13 is a simplified diagram of an application, that is in the prior art, running on one computer device whose graphic elements are connected as a DAG (Directed Acyclic Graph). The source node is the application and the sink node is the surface composer. The pixel rendering elements are adjacent to the surface composer. This diagram is a different view of the functionality equivalent FIG. 6.

FIG. 14 A screenshot of the Google Android™ Gmail app. This is an example of an application that is rendered by a non-linear DAG of graphic elements.

FIG. 15 A simplified diagram of connected graphical elements that can render frames such as the Gmail app of FIG. 14.

FIG. 16 A simplified diagram of the distributed graphics system described by of LISTINGS 1-5.

FIG. 17 A simplified diagram of a system composed of graphical aggregates.

FIG. 18 An expanded view of element 1702 from FIG. 17.

FIG. 19 A simplified diagram of the remote graphics system.

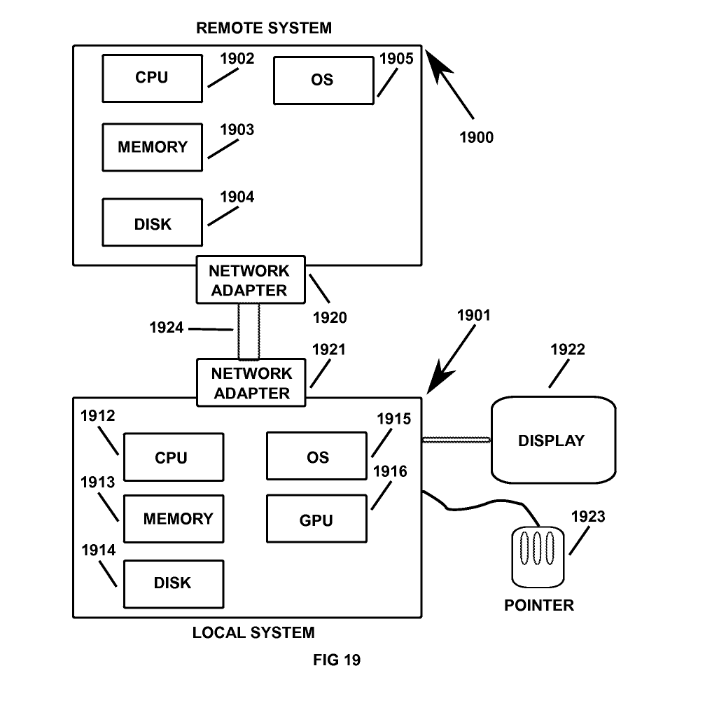

### BRIEF DESCRIPTION OF THE TABLES

TABLE 1 shows the commands executed on the local client for the remote server of LISTING 3 and the local client of LISTING 4.

### BRIEF DESCRIPTION OF THE LISTINGS

LISTING 1 shows a C++ header file that describes the three-level rendering stack.

LISTING 2 shows the C++ implementation of the three-level rendering stack.

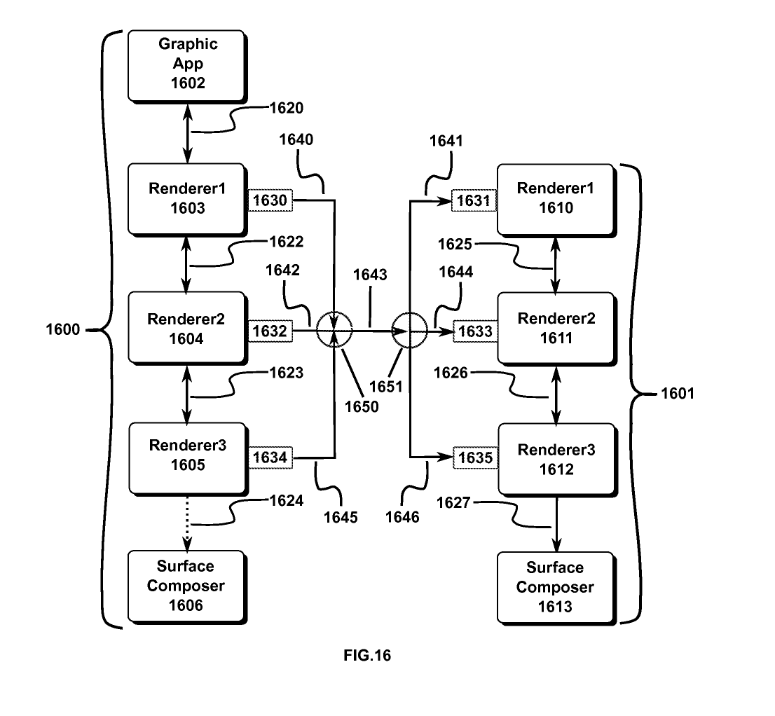

LISTING 3 shows the modified C++ sources that can be used to implement the remote rendering stack of FIG. 16.

LISTING 4 shows procedures of the local rendering stack of FIG. 16.

LISTING 5 shows the modified C++ sources that can be used to implement the remote rendering stack of FIG. 16, while avoiding unwanted duplicate rendering.

### DETAILED DESCRIPTION OF THE INVENTION

System Hardware and Operating Software

In this description of the computer hardware only item of relevance are noted. The systems comprises of two system connected via a communication channel 1924. The remote system 1900 typically does not have a human interface. It might be located what colloquially is called the “Cloud”. The remote CPU 1902 is needed to run the application and manage the hardware resources. The memory 1903 is used to store the executing programs and data. The disk 1904 will store persistent program images and data. The operating system (OS) 1905 provides the infrastructure that will allow user programs to run an access system resources. The network adapter 1920 will allow the remote system to communicate with systems that are connected via a common network. The computer network 1924 might be an isolated LAN (local area network) or might give connectivity to the global Internet.

The local system 1901 has means for user interaction. The display 1922 will allow graphics to be shown. There will usually be some type of human interaction available (mouse, touch screen, keyboard) 1923. The local system contains a CPU 1912, memory 1913, disk 1914 and OS 1915 as was noted in the remote system. In addition the GPU (Graphics Processing Unit) 1916 is useful for rendering graphics on the local display 1922. There might be a GPU on the remote system but typically it will not be needed.

System Overview

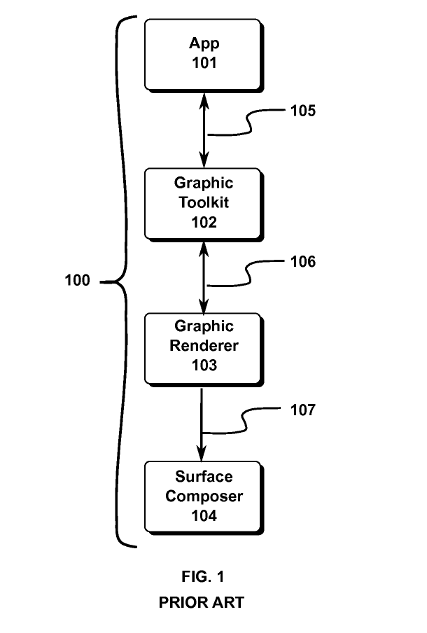

A typical graphics software stack 100 is shown in FIG. 1. The user application 101 uses the API of the Graphical Toolkit 102. The Graphical Toolkit 102 uses the API of the Graphical Renderer 103 to render the actual pixels on a buffer. The surface composer 104 will compose the graphical image rendered by the Graphical Renderer 103 onto the graphical display. The arrow 105 indicates the interaction between the user application 101 and the Graphical Toolkit 102. The arrow 106 indicates the interaction between the Graphical Toolkit 102 and the Graphical Renderer 103. The arrow 107 indicates the interaction between the Graphical Renderer 103 and the surface composer 104. In some embodiments, the surface composer 104 is absent and the Graphical Renderer 103 renders on the graphical display directly, not on an intermediate pixel buffer. In other embodiments the user application 101 and the Graphical Toolkit 102 might be merged into one entity or expanded into more than two entities. The links 105, 106 and 107 between the elements in this drawing and in the following drawings represent software procedure calls. In this drawing, the downward directed arrows are the procedure invocation (calls) and the upward directed arrows represents the procedure return values. Normally the relationship between elements of the graphic software stack are fixed. For example: the user application 101 calls routines of the Graphical Toolkit 102 and receives return values from the Graphical Toolkit 102. Callbacks are instances where the Graphical Toolkit 102 calls routines that are within the user application 101. These routines are registered by the user application 101 with the Graphical Toolkit 102 and are a mechanism to extend the functionality of Graphical Toolkit 102. Logically, they should be considered part of the Graphical Toolkit 102.

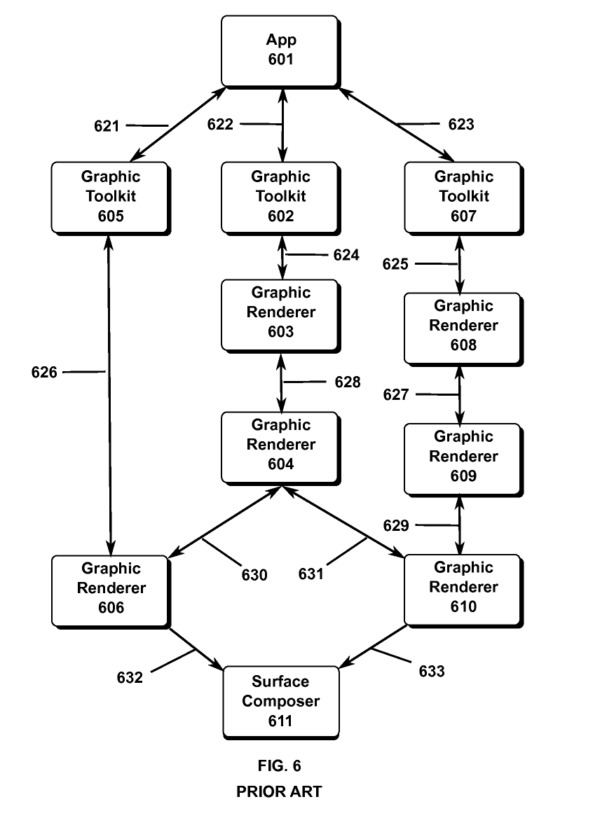

A more elaborate graphics software stack is shown in FIG. 6. The exact details are not representative of an actual application but rather have been selected to illustrate diverse combinations of rendering stacks. In this figure, the user application 601 uses three different graphic toolkits, each one partially rendering the graphic frame. The interaction between the application and the graphic toolkit's APIs are represented by the bidirectional arrows 621, 622 and 623. The graphic toolkits 605, 602 and 607 each interact with their respective rendering stacks represented by the bidirectional arrows 626, 624 and 625 respectively. The leftmost graphics rendering stack has one element 606. The rightmost rendering stack has three elements 608, 609 and 610, whose interactions are represented by the bidirectional arrows 627 and 629. The middle graphic rendering stack uses elements 603, 604, 606 and 610, whose interactions are represented by the bidirectional arrows 628, 630 and 631. The graphic renderer element 606 interacts with the surface composer via 632. The graphic renderer element 610 interacts with the surface composer via 633.

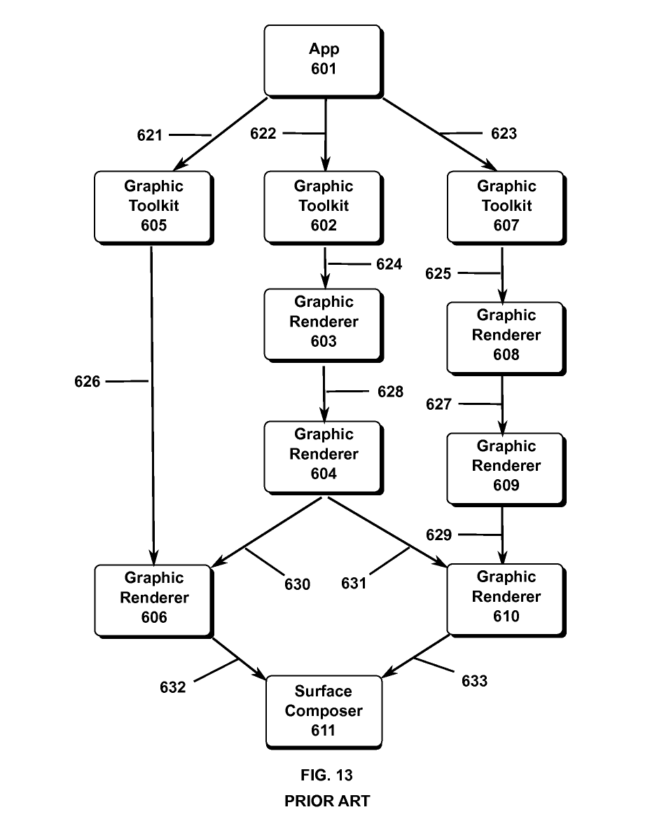

FIG. 6 shows an application that uses three graphics stacks to collectively render individual frames. In general the major flow of API data is in the top-down direction in the figures and the data volume increases as the graphical elements are closer to the surface composer. The flow of control between the graphical elements can be split into multiple instances of graphic elements as in 630-631 from the graphic renderer 604. In other cases the flow of control can be directed from more than one graphical elements into one element as in 631 and 629 into graphical renderer 610. The graph as shown in FIG. 6 is depicted as an undirected graph (two-way links) since the procedural interface between the graphic elements send data in one direction (procedural arguments) and receives data as procedural results. The only exceptions are in the links connecting the surface composer 632-633 that are drawn as directed arrows to emphasize that the transferring of the frame's pixels yields no significant return value. FIG. 13 depicts the same system that is shown in FIG. 6. The difference is that the links between the elements are shown oriented in the direction of argument passing to the API calls. The relationship between the graphic elements will then be an acyclic directed graph (DAG). The source of the DAG would be the App 601 and the sink of the DAG would be the surface composer 611.

Graphic elements directly connected to the surface composer are elements that render the pixels. They are denoted as “pixel rendering elements”. In FIG. 6 the pixel rendering elements are 606 and 610. The other graphical elements 602-609 will be denoted as “non-pixel” rendering elements. They do not render pixels but typically transform the graphical commands from more abstract to more concrete form. For example, the APIs between the application 601 and the graphical toolkit elements 605, 602 and 607 have as their abstractions widgets such as buttons, labels and lists. The APIs between graphical toolkit elements 605, 602 and 607 and the graphical renderers elements 606, 603 and 608 have abstractions such as lines, circles, text and boxes. Graphical widgets such as buttons are expanded into multiple commands, such as boxes, lines and text, when sent to the graphical rendering elements. As indicated earlier, in general, the volume of data needed for the procedure arguments increases and the level of abstraction of these arguments decreases as the graphic element's distance to the surface composer decreases. Typically the greatest expansion in the data of the procedural arguments occurs between the pixel rendering elements and the surface composer. The reason for this is that the interface data, 632-633, produced by the pixel rendering elements, 606 and 610, are the pixels of a fully rendered frame which typically might number in the millions of pixels. The interface data, 621-623, produced by the app 601 is proportional to the number of widgets comprising a frame which is typically less than one hundred. The abstractions of the application-toolkit interface 621-623, are high-level widgets while the abstractions of the surface composer interface 632-633 are low-level pixels. The other interface data 624-631 are typically intermediate between the application-toolkit interface 621-623 and the surface composer interface 632-633 in terms of data volume and the level of the abstractions.

Description of Android™

Android™ is an operating system and a collection of associated applications for mobile devices such as smartphones and tablet computers. In the relatively short period that Android™ has been distributed, it has captured significant market share. A notable difference to previously introduced mobile operating environments is that Android™ is distributed as open source under relatively permissive usage terms, thus allowing modification and inspection of any part of the software infrastructure.

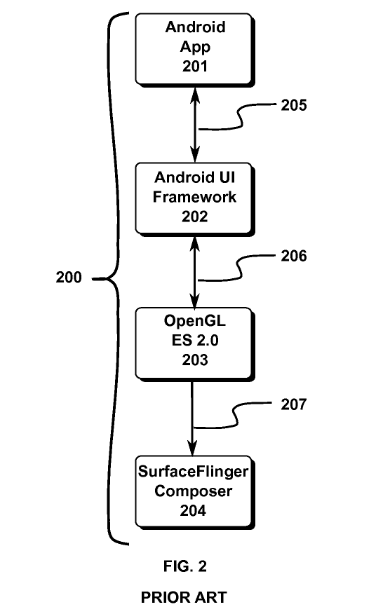

FIG. 2 shows Android™'s graphical software stack 200. It should be compared to the generic graphical software stack of FIG. 1. The graphical application (app) 201 is written to an Android™ specific graphical interface. Android™ introduced a new GUI 202 that was based on a Java language application programming interface (API). The rendering component 203 of the graphics stack is based on either the SKIA renderer in older versions of Android or OpenGL ES 2.0 in the latest versions of Android. In FIG. 2 OpenGL ES 2.0 is shown as the pixel renderer. The SKIA rendering library is distributed as open source software. OpenGL ES 2.0 is an open standard with wide support. The SurfaceFlinger 204 deals with graphical buffer allocation, double buffering and copying these buffers to the device's framebuffer. The arrows 205, 206, 207 indicate the transfer of data between the stack elements 201-204.

Android™ differs from other graphical rendering systems in its rendering strategy. The X11 Window system uses off-screen rendering and damage notification to try to minimize re-rendering of the screenbuffer. The main rationale for this is that X11 was designed to support remote graphics and is thus frugal with rendering commands. In contrast, Android™ re-renders complete frames at high refresh rates. No contingency for remote graphics was made available.

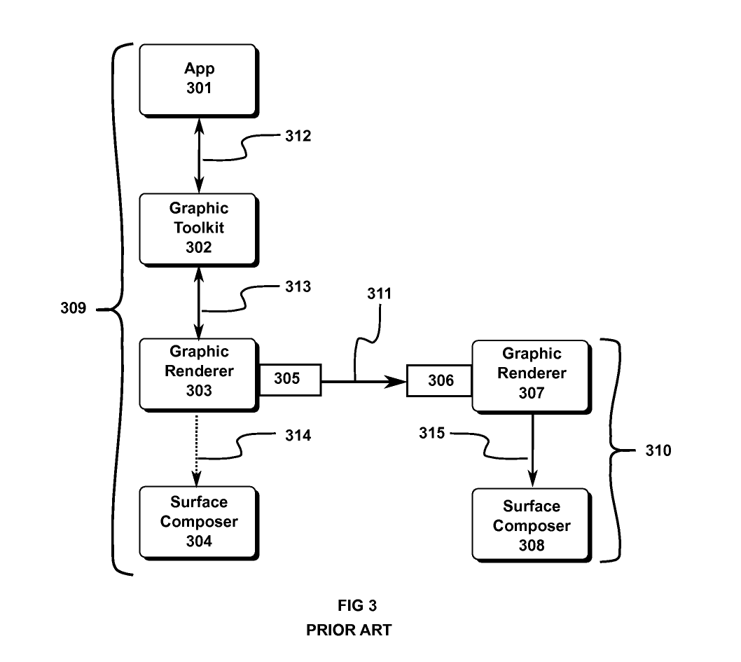

Prior Art of Remote Graphics—FIG. 3

A system software overview of U.S. Patent Application No. 2012/0113091 A1 is shown in FIG. 3. Here the graphics stack of FIG. 2 has been modified to allow rendering to be distributed between two separate devices. The lefthand side of the figure shows the standard graphics stack of a mobile device 309 that will be referred to as the remote device. The right hand side of the figure shows the truncated graphics stack 310 that will be referred to as the local device.

The user application 301 uses the API of the graphical toolkit 302. The graphical toolkit 302 uses the API of the graphical renderer 303. The arrow 312 indicates the interaction between the user application 301 and the graphical toolkit 302. The arrow 313 indicates the interaction between the graphical toolkit 302 and the graphical renderer 303. The arrow 314 indicates the interaction between the graphical renderer 303 and the surface composer 304. The stack 309 has been modified, from the stack in FIG. 3, to forward requests from the graphical renderer 303, via an extension stub 305, which sends graphical rendering requests via a network connection 311, to an extension stub 306, that relays graphical rendering requests to a Graphic Renderer 307 on the local device to render the actual pixels on a buffer. The truncated graphics stack 310 will render 307 and via 315 compose 308 the graphical image on the local device. In some embodiments the surface composer 308 is absent and the graphical renderer 307 renders on the graphical display directly not on an intermediate pixel buffer. In other embodiments, the user application 301 and the graphical toolkit 302 might be merged into one element or expanded into more than two elements.

The extension stub 305 takes a sequence of rendering commands and assembles them into a serial data stream suitable for transmission via the network link 311 and transmits this data stream. The extension stub 306 receives the serial data stream and disassembles it into a sequence of rendering commands suitable for the Graphic Renderer 307.

The Graphic Renderer 303 does not normally pass requests to the surface composer 304, via 314, since graphical output at the remote device is not normally required at the remote location. This will lessen the computation load on the remote device. The link 314 is drawn as a dotted line to indicate that this connection is not normally required.

The stream of graphical rendering 311 transfers information in one direction only. This simplex transfer pattern will prevent network round-trip latency from slowing down graphical performance. The volume of data passing through the rendering stream 311 can be greatly compressed with suitable techniques. There are some instances where transfer of information is in the opposite direction, such as initializations and local user input, these are low in frequency and bandwidth and are ignored in the drawing.

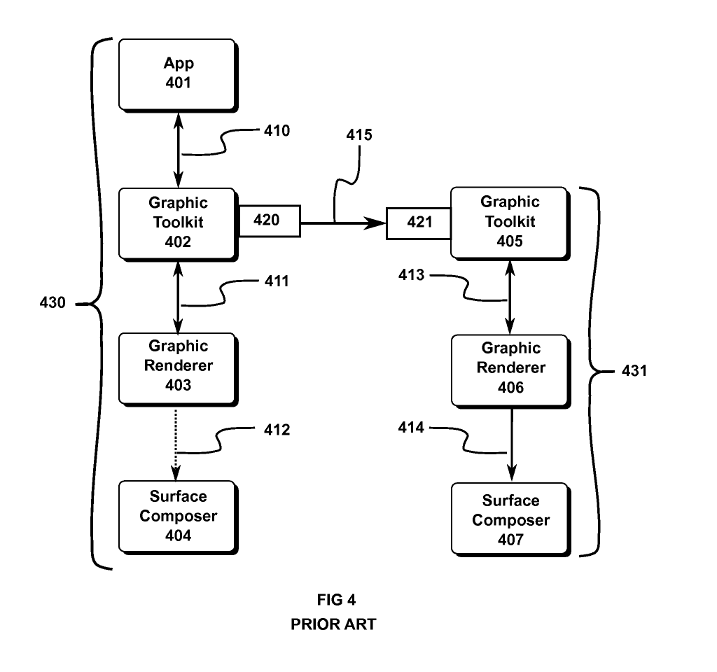

Prior Art of Remote Graphics—FIG. 4

An additional system software approach to remote graphics taught in U.S. Patent Application No. 2012/0113091 A1 is shown in FIG. 4. Here the graphics stack of FIG. 2 has been modified to allow rendering to be distributed between two separate devices. The lefthand side of the figure shows the standard graphics stack of a mobile device 430 that will be referred to as the remote device. The right hand side of the figure shows the truncated graphics stack 431 that will be referred to as the local device.

The general structure of this solution to provide remote graphics is similar to FIG. 3. The remote graphical stack 401, 402, 403 and 404 have similar functionality to 301-304. The interaction between the graphical elements of the remote device is via the links 410, 411 and 412. In this system the remote graphic commands are exported at the Graphic Toolkit level 402. The extension stub 420 takes a sequence of toolkit commands and assembles them into a serial data stream suitable for transmission via the network link 415 to the extension stub 421 which receives the serial data stream and disassembles it into a sequence of rendering commands suitable for the Graphic Toolkit 405. The Graphic Toolkit 405 on the local device sends rendering commands via 413 to the Graphical Render 406 to render the actual pixels on a buffer. The rendered pixels are sent via 414 and composed by 407 on the local graphical device.

As noted in U.S. Patent Application No. 2012/0113091 exporting graphics from the toolkit level is difficult. A widget toolkit, widget library, or GUI toolkit is a set of widgets for use in designing applications with graphical user interfaces (GUIs). The difficulty is increased if the toolkit is extensible since in that case the widgets can't be simply enumerated and exported to the local system. For this reason we will not consider exporting graphics via toolkit elements that are extensible, i.e. stubs can not be instrumented for these elements. For non-extensible toolkits elements, such as HTML renderer widgets, we can consider exporting their interfaces to the local device. Except for this restriction, toolkit elements can be thought of as being within the non-pixel rendering elements class.

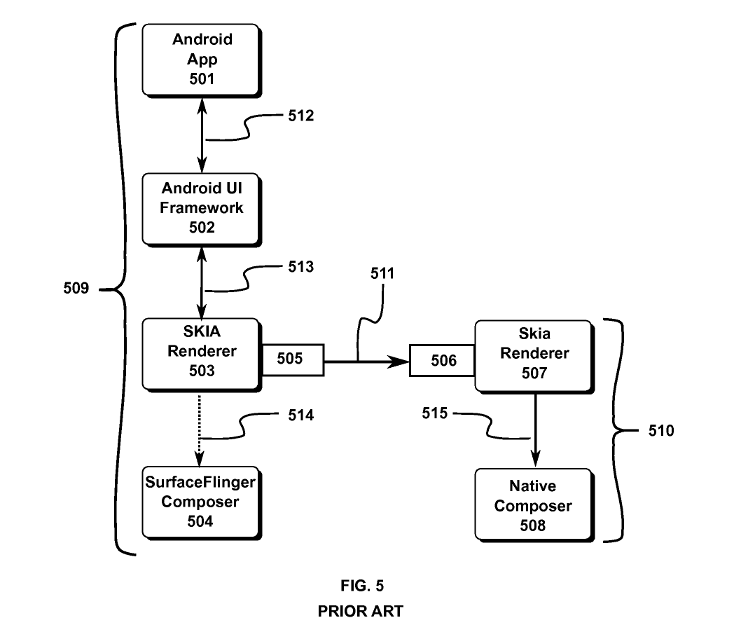

Prior Art of Remote Graphics—FIG. 5

An additional system software overview taught in U.S. Patent Application No. 2012/0113091 A1 is shown in FIG. 5 which should be compared to the more general system FIG. 3. The remote system 509, essentially runs the standard Android™ graphical software stack (FIG. 2). The Android™ application 501, GUI 502, renderer 503 and their connections 512 and 513 function as in FIG. 2. Here SKIA is shown as the pixel renderer. OpenGL ES 2.0 can be similarly used as the pixel renderer. The composer 504 and its connection 514 are typically not used. The additional component added to the remote system is the extension stub 505. The extension stub 505 will assemble the rendering commands into a serial data stream. This modification to the Android™ graphical software stack is facilitated by the permissive “Open Source” license used in the graphical software stack. The SKIA rendering library 503 is distributed under the Apache License, Version 2.0. This allows the source to be examined, modified, extended, recompiled and distributed. This is how the remote rendering extension stub 505 is implemented. Since the SKIA renderer 503 is a shared library, once the library with the extension stub 505 is installed, all Android™ apps 501 will use the new library. Thus all applications that use SKIA, including those in the Android™ Market, will then be remotely accessible.

The local system 510, also includes an instance of the SKIA rendering library 507. Here again we use the same strategy that was used in the remote system. The SKIA rendering library is extended to create the local rendering extension stub 506. The extension stub 506 will disassemble the serial data stream into a sequence of rendering commands. The Native Composer 508 of FIG. 5 will use the native graphical composition capabilities of the local system 510 in this embodiment. Examples of capable graphical composers might be those of the X11 Window System, Microsoft WINDOWS® or Mac OS. For a native X11 graphics platform the SKIA Renderer 507 renders directly, via 515, into X11 shared memory pixmaps and then has the X11 server display the pixmap using the XShmPutImage( ) X11 Shared Memory, extension function. This approach closely parallels the functionality of the SurfaceFlinger in Android™.

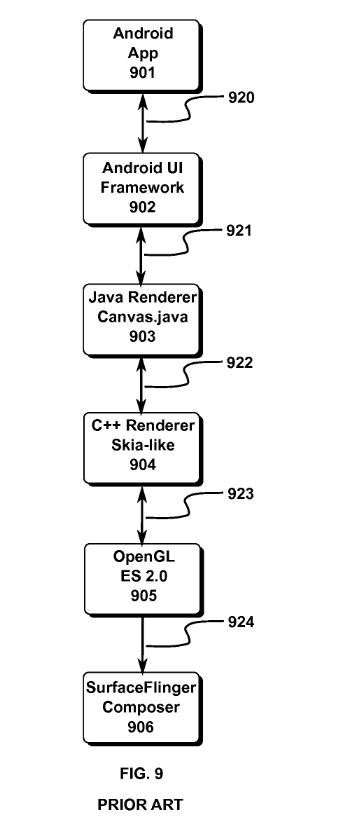

Prior Art of Remote Graphics—FIG. 9

FIG. 9 shows the standard Android™ graphics stack. It is an expansion of FIG. 2. The Android App 901 of FIG. 9 corresponds to the App of 201 of FIG. 2. The Android UI Framework 902 of FIG. 9 corresponds to the UI Framework 202 of FIG. 2. The SurfaceFlinger Composer 906 of FIG. 9 corresponds to the Composer 204 of FIG. 2. The renderer element 203 of FIG. 2 is expanded into three elements 903, 904 and 905 in FIG. 9. FIG. 9 has the structure of the rightmost path 601, 623, 607, 625, 608, 627, 609, 629, 610, 633 and 611 of FIG. 6.

Element 903 is the Java View rendering element. It has a SKIA-like interface.

Element 904 is the C++ rendering element that interfaces with the Java View rendering element 903. Its interface is similar to both SKIA and the Java View rendering element. It is defined in the C++ OpenGLRenderer.cpp file. Element 904 converts its SKIA-like interface into OpenGL ES 2.0 calls. Element 905 is the standard OpenGL ES 2.0 library. It normally uses a hardware GPU to render pixels.

It possible to run most older Android™ application using an alternate software rendering stack. In this case the renderer 904 uses the element defined in the C++ Canvas.cpp file. The renderer 905 would be the SKIA renderer instead of OpenGL ES 2.0 renderer. The rendered graphics are very similar in both cases.

The calling arguments passing through the interfaces 920, 921, 922, 923 and 924 are each sufficient to generate the graphics that are displayed by the Android™ application.

The pixel frames and composition parameters 924 can generate the application graphics when passed to SurfaceFlinger Composer 906.

The OpenGL ES 2.0 API stream 923 can generate the application graphics when passed to the OpenGL ES 2.0 element 905 coupled to the SurfaceFlinger Composer 906.

The stream 922 can generate the application graphics when passed to the OpenGLRenderer.cpp element 904 coupled to the OpenGL ES 2.0 element 905 and to the SurfaceFlinger Composer 906.

The stream 921 can generate the application graphics when passed to the Canvas class element 903 coupled to the OpenGLRenderer.cpp element 904, to the OpenGL ES 2.0 element 905 and to the SurfaceFlinger Composer 906.

The stream 920 can generate the application graphics when passed to the Android UI Framework (the toolkit) 902 coupled to the View class element 903, to the OpenGLRenderer.cpp element 904, to the OpenGL ES 2.0 element 905 and to the SurfaceFlinger Composer 906.

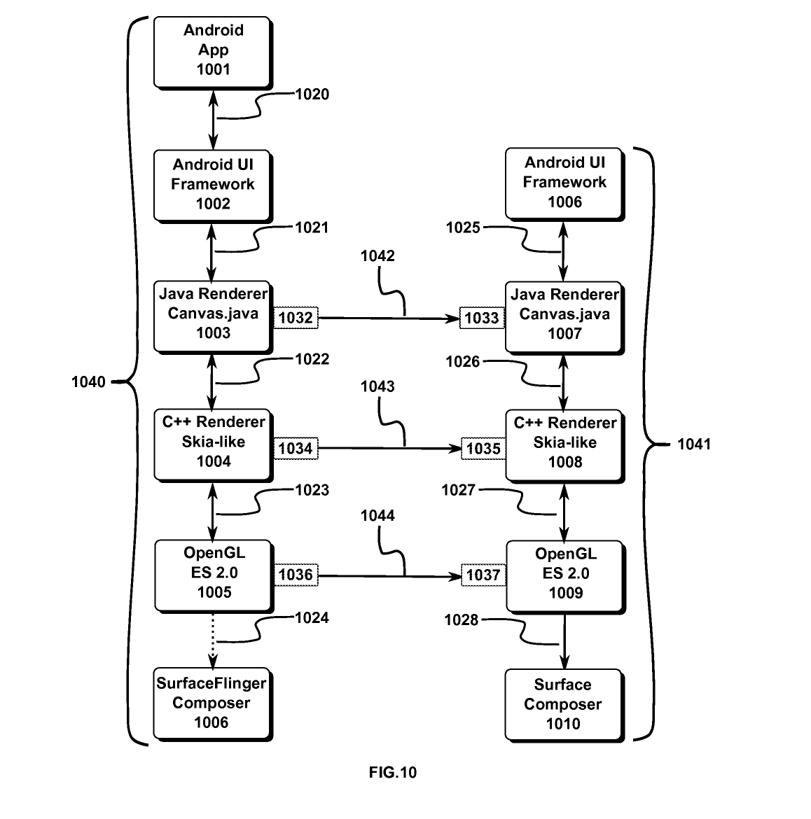

### Embodiment of FIG. 10

FIG. 10 shows a distributed computer system that allows remote graphic display. The remote side 1040 is a standard Android™ software stack except possibly for the SurfaceFlinger Composer element 1006 and its connection link 1024. The OpenGL ES 2.0 element 1005 might be modified to bypass pixel rendering if pixels are not needed. A modified renderer 1005 will use less computational resources be it software (CPU cycles) or hardware (GPU). The C++ Renderer 1004 is contained primarily in the OpenGLRenderer.cpp file in the Android™ source code. The 1004 renderer transforms the SKIA-like API, transferred over link 1022, into OpenGL ES 2.0 commands transferred over link 1023. The 1003 renderer transforms the incoming Java Canvas class calls 1021 into the SKIA-like API of link 1022. The Android™ UI Framework (toolkit) 1002 transforms the incoming class View calls 1020 into calls to the Canvas class calls via 1021. The Android™ App 1001 uses the Java class View calls via 1020 to execute toolkit procedures.

The elements 1002-1005 have been instrumented with stubs to serialize their incoming interfaces. These are shown as boxes 1032, 1034 and 1036. These remote stubs are connected via the links 1042, 1043 and 1044 to the corresponding local stubs 1033, 1035 and 1037 on the local system 1041. Although the links 1040-1044 are shown as distinct links they usually will be implemented as one multiplexed link that, on the local side, will demultiplex the remote API requests to the targeted local graphical element 1006-1009. The local system 1041 has a software stack that is similar to the remote system except for the absence of the specific application 1001 that is on the remote system 1040. The local system will render pixels in the pixel rendering element 1009 and pass it on to the local means of composing graphics on the local display 1010.

The local 1041 system's graphics elements are 1006, 1007, 1008, 1009 and 1010 that are interconnected by the APIs of 1025, 1026, 1027 and 1028.

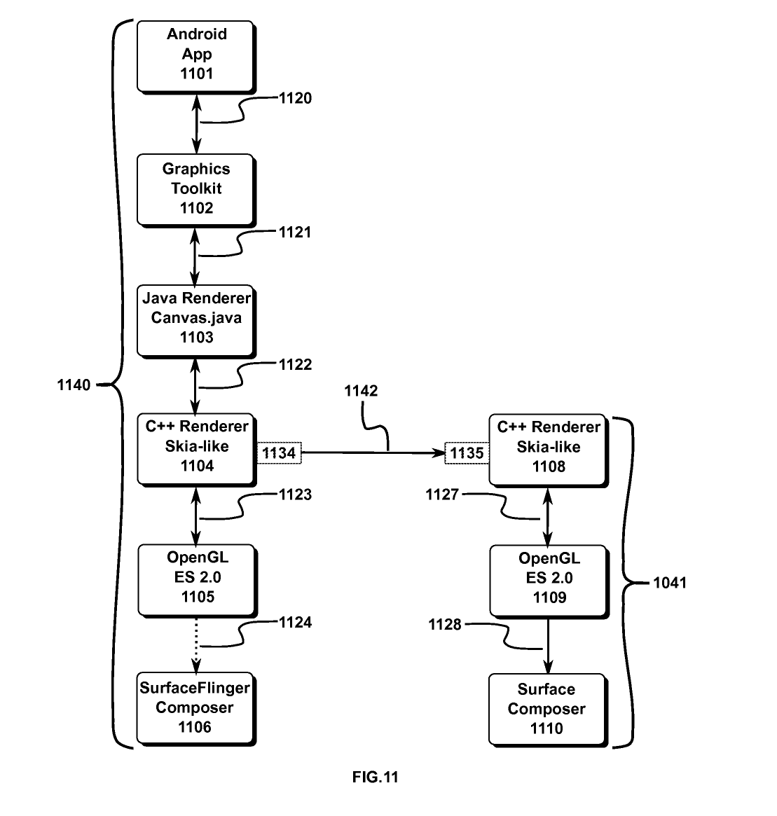

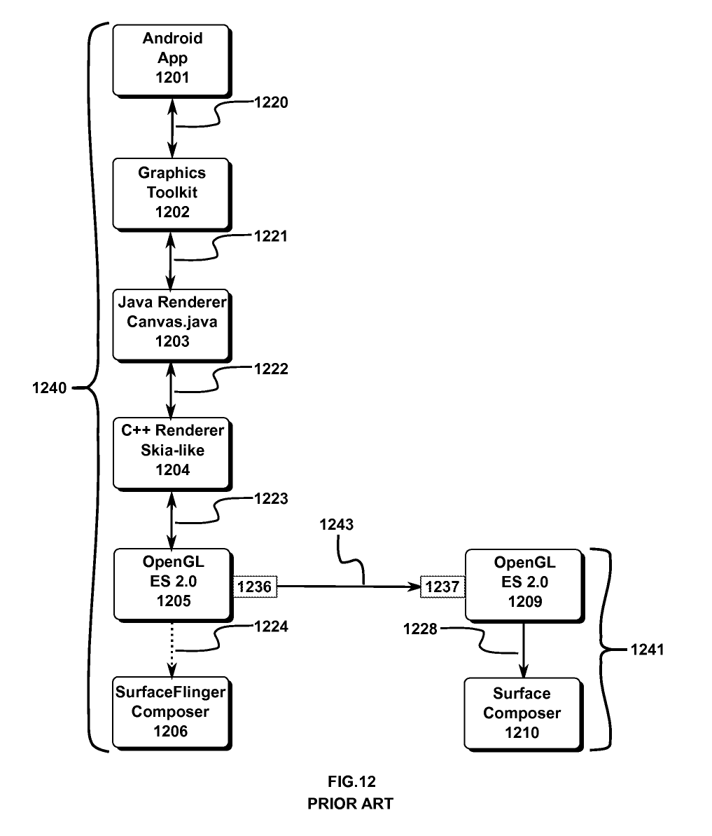

It should be appreciated that frequently only one API will need to be exported from the remote end to transfer graphics to the local end. The completeness of each of the API calling sequences has been taught in paragraph 0074. This property leads to the possibility of simpler systems configurations that allow remote-local graphics for similar sets of applications. FIG. 11 and FIG. 12 show different systems that will support similar remote applications displaying local graphics on displays.

### Embodiment of FIG. 11

FIG. 11 shows a remote graphics stack which is very similar to the remote graphics stack of FIG. 10 and FIG. 12. The main difference is that only the C++ Renderer 1104 has been instrumented with a stub 1134 which will capture the 1122 API. The remote stub 1134 communicates with local stub 1135 via the 1142 channel. The graphical elements corresponding to 1006 and 1007 appearing in FIG. 10 do not appear and are not needed in FIG. 11 since their APIs are not called.

FIG. 11 contains the remote 1140 graphical elements 1101, 1102, 1103, 1104, 1105 and 1106 that are connected via the APIs 1120, 1121, 1122, 1123 and possibly 1124. Remote stub 1134 is connected to the link 1142 and to the local stub 1135. The local graphics stack 1141 has three elements 1108, 1109 and 1110 connected with APIs 1127 and 1128.

As noted, the SurfaceFlinger 1106 can frequently be dispensed with if pixels are not rendered on the remote server. Also as noted, the OpenGL element 1105 can frequently be modified to bypass pixel rendering if pixels are not needed on the remote server. Since the graphical interface is exported from a non-pixel rendering element it might also be possible to do without the OpenGL element 1105 completely if the OpenGLRenderer.cpp element 1104 can make do without responses from the OpenGL API calls that it generates. It might also be possible to modify the OpenGLRenderer.cpp element 1104 not to generate calls to OpenGL at all. Doing less intensive work on the remote server will allow it to support more local clients.

### Embodiment of FIG. 12

### In the Prior Art

FIG. 12 shows a remote graphics stack which is very similar to the remote graphics stack of FIG. 10 and FIG. 11. The main difference is that only the C++ Renderer 1205 has been instrumented with a stub 1236 which will capture the 1223 API. The remote stub 1236 communicates with local stub 1237 via the 1243 channel. The graphical elements corresponding to 1006, 1007 and 1008 appearing in FIG. 10 do not appear and are not needed in FIG. 12 since their APIs are not called.

FIG. 12 contains the remote 1240 graphical elements 1201, 1202, 1203, 1204, 1205 and 1206 that are connected via the APIs 1220, 1221, 1222, 1223 and possibly 1224. Remote stub 1236 is connected to the link 1243 and to the local stub 1237. The local graphics stack 1241 has two elements 1209 and 1210 connected with API 1228.

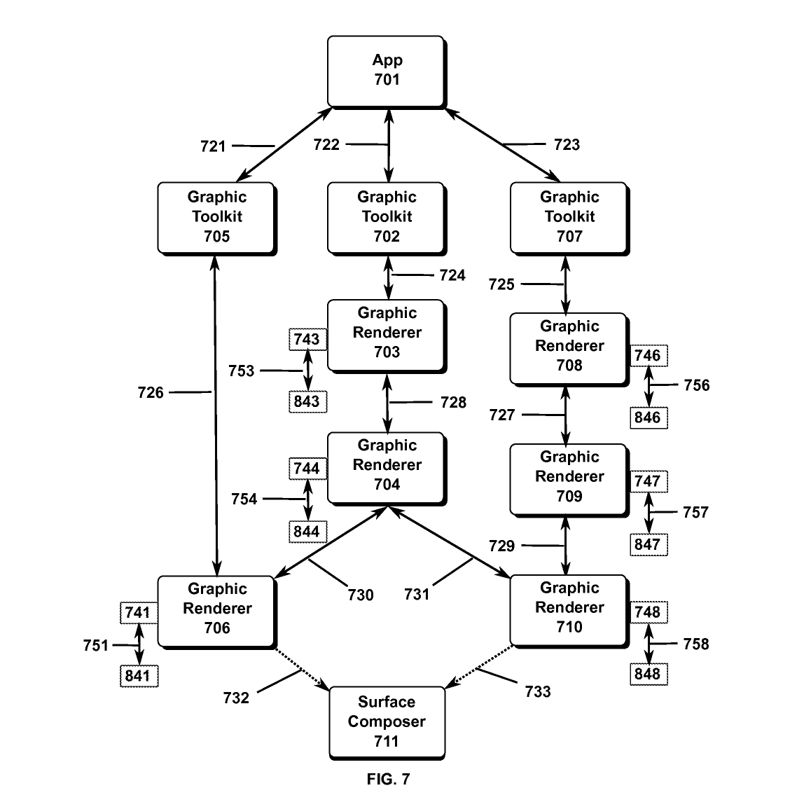

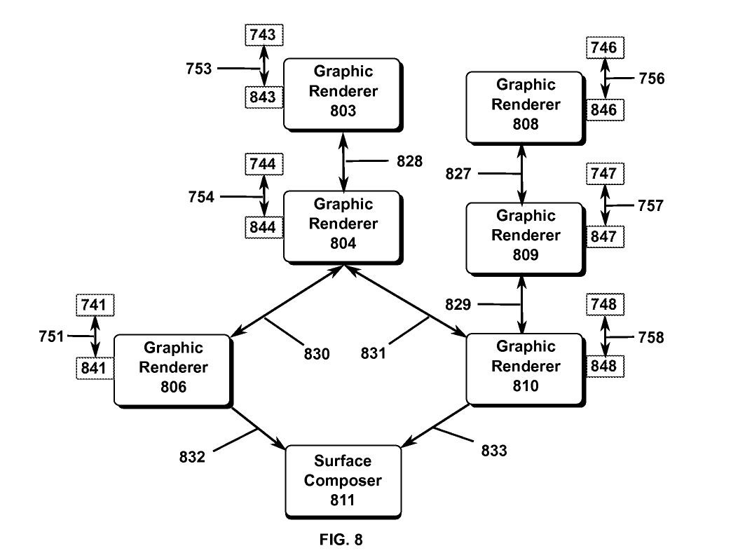

### Embodiment of FIG. 7 and FIG. 8

FIG. 6 is more complex than the linear stack example of FIG. 9. As shown in FIG. 7 there are six possible stub attachments 741, 743, 744, 746, 747 and 748. Of course as seen in FIG. 11 and FIG. 12 not all possible stubs are needed to deliver the graphical content to the local client. For example: stubs 741 and 748 are sufficient to export the graphical content. Other combinations of stubs such as 741, 744 and 747 can deliver the remote graphics to the local client but it can cause unwanted duplicate rendering commands to be executed. This problem will be addressed later in the description. The two drawings FIG. 7 and FIG. 8 show one system. FIG. 7 shows the remote end and FIG. 8, the local end.

FIG. 7 shows the same eleven graphic elements of FIG. 6. They are 701, 702, 703, 704, 705, 706, 707, 708, 709, 710 and 711. The surface composer 711 typically is not needed on the server. The connections between the graphic elements are 721, 722, 723, 724, 725, 726, 727, 728, 729, 730, 731, 732 and 733. The remote stubs are 741, 743, 744, 746, 747, 748. They are connected via the links 751, 753, 754, 756, 757 and 758 to the local client stubs. The local client stubs are 841, 843, 844, 846, 847 and 848.

FIG. 8 shows some of the same graphic elements of FIG. 6. They are 803, 804, 806, 808, 809, 810 and 811. The connections between the graphic elements are 827, 828, 829, 830, 831, 832 and 833. The remote stubs are 741, 743, 744, 746, 747 and 748. They are connected via the links 751, 753, 754, 756, 757 and 758 to the local client stubs. The local client stubs are 841, 843, 844, 846, 847 and 848.

Frames Composed from Multiple Renderers

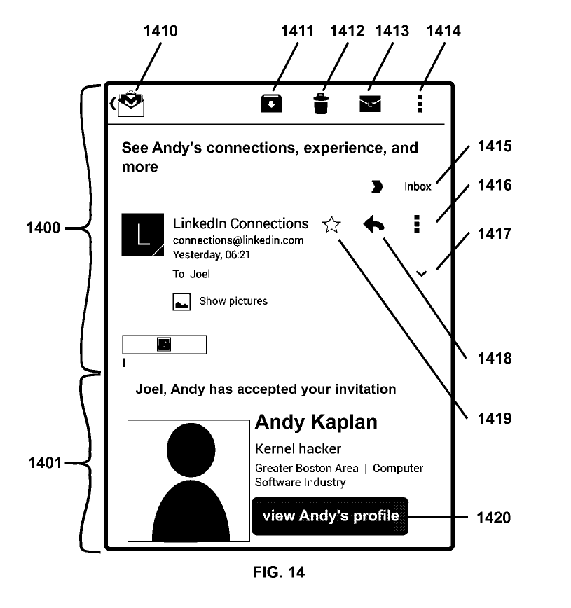

FIG. 14 shows a frame taken from the standard Android™ Gmail application. An examination of the rendering needed to compose this frame shows that there are two different technologies involved. The larger upper rectangle delineated by the large bracket 1400 is rendered with the standard Android™ View toolkit. The widgets 1410, 1411, 1412, 1413, 1414, 1415, 1416, 1417, 1418 and 1419 are taken from the standard Android™ UI. Interaction with these widgets will activate callbacks in the application program.

The smaller lower rectangle delineated by the smaller bracket 1401 is rendered, in this case, from the HTML embedded in the email message. The standard way to render HTML into an area in the graphics frame of Android™ is to use the WebView component of the Android™ UI. This widget takes HTML source data and renders to pixels using the WebKit rendering engine. Pressing on the widget 1420 will open a web page in the browser.

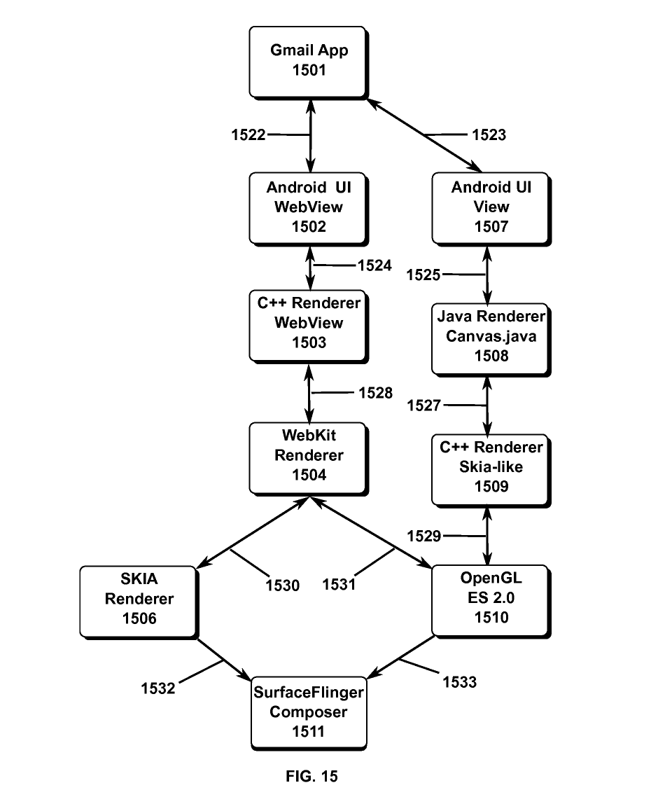

FIG. 15 shows a system representation of an email app that is similar to the Gmail app. Note the resemblance to the graphics software stack shown in FIG. 6. Here the right-most stack 1501, 1507, 1508, 1509, 1510 and 1511 with the connections 1523, 1525, 1527, 1529 and 1533 is essentially the same as FIG. 9. The other stack 1501, 1502, 1503, 1504, 1506, 1510 and 1511 with the connections 1522, 1524, 1526, 1530, 1531, 1532 and 1533 is more complex with a branch at the pixel rendering elements. The OpenGLRenderer.cpp element 1509 converts the SKIA-like calling sequences 1527 into OpenGL ES 2.0 output calling sequence 1529. The WebKit renderer element 1504 receives HTML input 1528 and might use either the SKIA renderer 1506, the OpenGL ES 2.0 renderer 1510 or both, depending on the WebKit version. Google's WebKit implementation originally used the software SKIA renderer library. Over time it was partially accelerated to use the GPU via OpenGL, but some use of SKIA remained. It is possible that in the future SKIA will be fully GPU accelerated and it will, in this case, cease to be a pixel renderer.

A Simple Multi-Level Rendering System

LISTING 1 and LISTING 2 show a simple multi-level rendering system that can be used to demonstrate how stubs can be added to both the remote and local rendering elements to enable remote graphics. In this system no toolkit is present. LISTING 1 is a C++ header file that describes the three-level rendering stack. LISTING 2 is the C++ implementation of the three-level rendering stack. In this example, for simplicity's sake, all three rendering level APIs use the same abstractions and rendering interfaces. Normally each rendering level would accept one API and call procedures of the next rendering interface that has a second API with different abstractions and interfaces.

The Rendering Interface

The first rendering API has two procedures, rend1_ellipse( ) and rend1_circle( ). rend1_circle( ) is defined by calling rend1_ellipse( ) having the horizontal and vertical axes equal to the circle's radii (LISTING 2, line 8-12). rend1_ellipse( ) is defined by calling the next rendering level's rend2_ellipse( ) (LISTING 2, line 3-6).

The second rendering API has two procedures, rend2_ellipse( ) and rend2_circle( ). rend2_circle( ) is defined by calling rend2_ellipse( ) having the horizontal and vertical axes equal to the circle's radii (LISTING 2, line 18-22). rend2_ellipse( ) is defined by calling the next rendering level's rend3_ellipse( ) (LISTING 2, line 13-16).

The third rendering API is a pixel renderer it being the only renderer that renders pixels. It has two procedures, rend3_ellipse( ) and rend3_circle( ). rend3_circle( ) is defined by calling rend3_ellipse( ) with the horizontal and vertical axes equal to the circle's radii (LISTING 2, line 28-31). rend3_ellipse( ) is the only rendering procedure that actually renders pixels and is defined by calling the next rendering level's rend3_ellipse_internal( )(LISTING 2, line 23-26).

System Diagram of the Three-Level Renderer—FIG. 16

FIG. 16 shows the system diagram for the three-level renderer. The unmodified C++ sources are shown in LISTING 1 and LISTING 2. These sources can be used in a system that displays local graphics on the system that the application runs on. LISTING 3 shows the modified C++ sources that can be used to implement the remote rendering stack 1600 of FIG. 16: the stack 1602, 1603, 1604 and 1605 plus the stubs 1630, 1632 and 1634. The interfaces 1620, 1622 and 1623 are simply the API of LISTING 1. The interface 1624 is not needed if pixels are not rendered on the remote system and in that case the remote surface composer 1606 is also not needed.

An alternative to the approach of LISTING 3 would be the use in UNIX and its derivatives (Linux, BSD and Android) of the standard LD_PRELOAD environment variable to allow function interposition of dynamically linked libraries. This will enable the functionality of LISTING 3 without having to edit and recompile shared system libraries. Similar functionality is available in Windows. Under IOS this functionality is partially available.

The stubs 1630, 1632 and 1634 are connected to the data links 1640, 1642 and 1645, respectively. Frequently it is advantageous to pass the data between the remote and local system via one data link since multiple data links would not necessarily preserve the remote order of invocation on the local client side. The multiplexer 1650 will take the rendering commands received on the incoming data links and transmit them in order of remote execution on the data link 1643. The multiplexed data stream is demultiplexed at the local client by the demultiplexer 1651. The three-fold data stream is reconstituted and send on the links 1641, 1644 and 1646. The multiple data streams of FIGS. 7-8 and FIG. 10 should be understood as implementable by this technique even though in the diagram it is shown as multiple separate streams.

FIG. 16—Remote Renderers and Stubs

LISTING 3 implements the renderer1 1603 and the stub 1630 in LISTING 3 lines 36-59. Each procedure uses a structure that contains the arguments of the procedure's API for serialization of the procedures calling sequence. The rend1_circle( ) procedure uses the circle_args structure to store the calling arguments of the procedure and to send the serialized calling sequence to the local side. The write_args( ) procedure sends this serialized calling sequence to the local client. The first argument of the write_args( ) procedure is an enum of type Args_type that identifies the procedure being called. All six (two procedures *three levels) procedures appear in LISTING 3. In the case where pixel rendering is not needed on the remote system, line 96 of LISTING 3 can be deleted and REND_GOOD can be returned.

FIG. 16—Local Renderers and Stubs

LISTING 4 shows procedures of 1601 the local rendering stack 1610, 1611, 1612 and 1613. The local stubs are 1631, 1633 and 1635. The links 1640, 1642 and 1644 are connected to the multiplexer. The interfaces 1625, 1626 and 1627 are as defined in LISTING 1. The main( ) procedure of LISTING 4, lines 3-62 loops as long as there is a valid serialized procedure call in the data stream. It executes read_type( ) to return the rendering procedure type and uses a switch procedure to read the calling arguments (read_args( )) for the rendering procedure and executes the rendering procedure with the unserialized arguments. The calls to rendering procedures such as rend1_circle( ) and rend3_ellipse( ) are from the unmodified file of LISTING 2.

TABLE 1 shows what would be executed in both the remote server and the local client when the single command rend1_circle (0x1234, 1.0, 2.0, 3.0, 0x3) is executed on the remote server for the C++ code of LISTING 3 and LISTING 4. Since all six APIs of the procedures in the graphics elements 1610, 1611 and 1612 have been instrumented with stubs to serialize and transmit to the local client, then for each procedure executed on the remote server multiple procedure executions are serialized and sent to the local client. In TABLE 1 four procedures are shown transmitted to the local client for the one rend1_circle( ) executed in the remote server. They are the procedures, rend1_circle( ), rend1_ellipse( ), rend2_ellipse( ) and rend3_ellipse( ). In addition, while these four routines are explicitly called, fourteen routines are called in total including rend3_ellipse_internal( ) which is called four times and renders pixels on the local client. This is the problem noted in paragraph 0074 where it was described as unwanted duplicate rendering.

One solution to this problem is to limit the instrumentation of the rendering interface to the pixel rendering element 1612 and to also limit the stub to the rend3_ellipse( ). This would cause only one rend3_ellipse( ) routine to be sent to the local client for any of the six rendering routines executed on the remote server. Thus the pixel rendering rend3_ellipse_internal( ) would be called once per rendering routine called on the server at any rendering level. This solution might not be optimal since the pixel rendering interface is usually not the most efficient interface for remote rendering. Experience shows that for standard Android™ applications exporting the graphics from the pixel rendering element OpenGL ES 2.0 (FIG. 10, link 1044) takes about five times more data than the higher level OpenGLRenderer.cpp (FIG. 10, link 1043) interface.

A general solution to the problem of duplicate rendering is shown in LISTING 5. Three global variables rend1_mask, rend2_mask and rend3_mask are used to keep track of the current state of application. LISTING 5 masks the sending of routine invocations if the application is not in the “upper level” state. Thus if rend1_circle( ) is called, the global variable rend1_mask is incremented before the rendering is invoked (LISTING 5, line 59). Sending the serialized arguments of the routine to the local client is only done if we are in the “upper level” state (i.e. rend1_mask==0). When the rend1_ellipse( ) is called, the state is rend1_mask !=0 and the serialized arguments of this routine will not be sent (line 42) to the local client. All other rendering routines will be masked until control is returned to the rend1_circle( ) (line 69) routine and the rend1_mask variable will be decremented to zero. Care must be take that incrementing and decrementing the masks are always balanced.

This approach solves the difficulty in FIG. 15 noted in paragraph 0074. If a mask variable is maintained in the OpenGLRenderer.ccp interface 1509 and if the OpenGL ES 2.0 interface 1510 checks this mask variable and masks itself then both the interface 1509 can be exported to the local client and the WebKit Renderer 1504 via the OpenGL ES 2.0 interface 1510. This mask will eliminate duplicate rendering routines being sent to the local client.

Graphical Aggregates

Dividing computational systems into components is an arbitrary but useful abstraction in computer systems. A simple example is the OpenGL API for rendering 2D and 3D computer graphics. The standard is managed by the non-profit technology consortium Khronos Group. Thus based on authorship and design it would seem to be logical to consider it a monolithic graphical element. A closer look reveals that many OpenGL extensions are the products of commercial companies and are proprietary. Are they to be considered as part of a monolithic OpenGL element? We can take the extreme approach and define a different element for each function call. The OpenGL API would then be composed of hundreds of interacting elements! Compact representations of systems such as FIG. 12 would not exist. On the other extreme we can arbitrarily combine software element into larger groups. An example of this might be the popular HTML WebKit renderer 1504 which has both SKIA 1506 and OpenGL 1510 pixel rendering “back-ends”. From a purely functional point of view it might make sense to combine these three elements {1504, 1506, 1510} into a compound element.

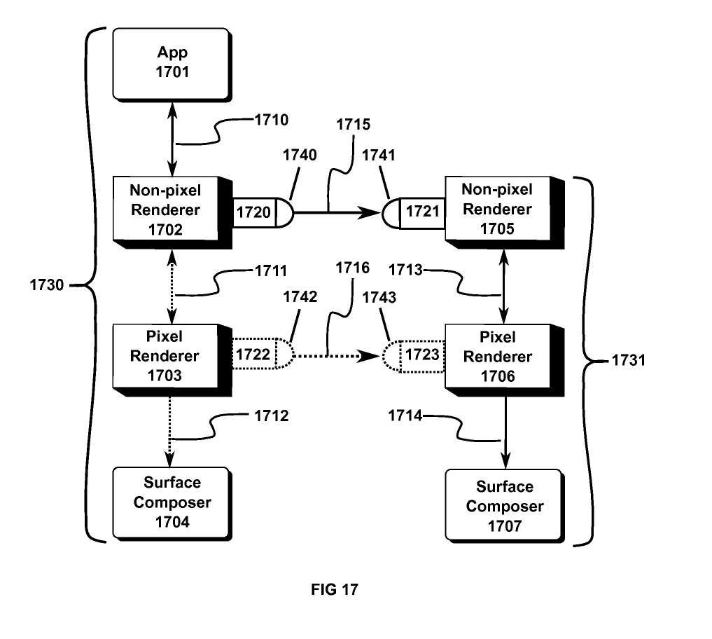

FIG. 17 show a more schematic view of the previous systems FIGS. 7, 8, 10, 11 and 16. The large boxes 1702, 1703, 1705 and 1706 will emphasize the aggregation of elements used to construct the graphical rendering element in FIG. 17. It illustrates the essential character of the remote graphical system. As noted, the partition of software into elements is always somewhat arbitrary. This partition might be functional, textural (source code files, classes or modules) or related to authorship. In FIG. 17 this partitioning distills the essential characteristics of our system. In this system view, the partitioning is into four classes. The application 1701 is usually characterized by being written by an author external to developers of the system infrastructure. The non-pixel rendering aggregates 1702 and 1705 are functionally characterized to comprise graphical elements that have a higher level of abstraction than the rendering of pixels. The pixel rendering aggregates 1703 and 1706 are characterized functionally by dealing with the rendering of pixels. The surface composers 1704 and 1707 display pixels on the graphical device.

The remote system 1730 has an application 1701 and a non-pixel renderer aggregate stub 1720 connected by transmitter 1740 to the data channel 1715. Both the pixel rendering aggregate 1703 and the surface composer 1704 might be absent in some systems. There are instances where the pixel renderer 1703 is needed (possibly to provide return values via 1711 to the non-pixel renderer) but the actual generation of pixels can be bypassed. This is advantageous since pixel rendering is costly both when it is performed in software (e.g. SKIA) or it is performed in hardware (e.g. GPUs). In some cases parts of the diagram connected to dotted lines might be absent. Thus 1711, 1703, 1722, 1716, 1723, 1712 and 1704 might be absent from some implementations. The stubs on the aggregation renderers 1720 and 1722 are connected to the data transmitters 1740 and 1742 respectively. The stubs on the aggregation renderers 1721 and 1723 are connected to the receivers 1741 and 1743 respectively.

Aggregation of Stubs

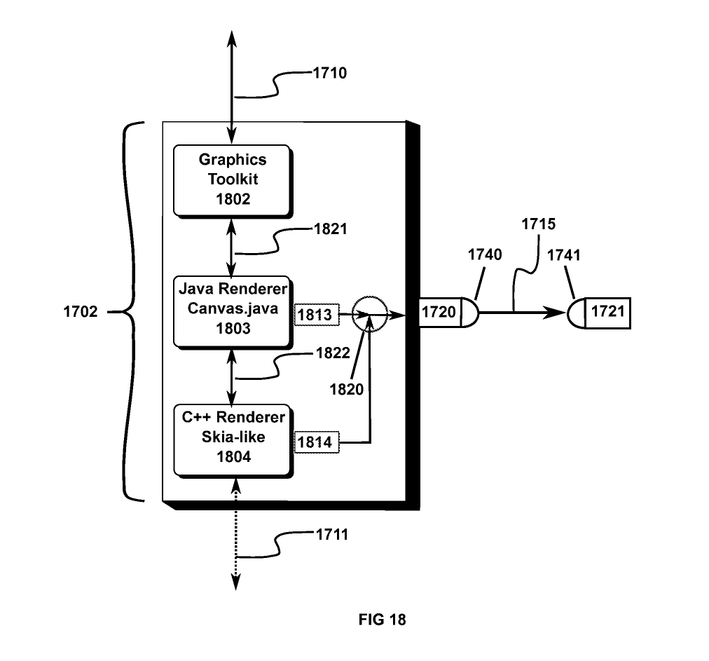

The stubs on the aggregation renderers 1720, 1721, 1722 and 1723 can be constructed from the stubs of the element renderers. The approach is similar to multiplexing data streams in FIG. 16. FIG. 18 shows how the stub of non-pixel rendering aggregate 1702 (FIG. 17) that is composed, in this example, of three internal non-pixel rendering elements can be constructed by two-way multiplexing 1820 the output of the two stubs 1813 and 1814 of the two non-pixel rendering elements 1803 and 1804. The graphical toolkit 1802 has no stub. The internal links between the rendering elements are 1821 and 1822. The external links are 1710 and 1711 as shown in FIG. 17 and FIG. 18. The local stub 1721 can be constructed in a similar manner by using a three-way demultiplexer in the non-pixel rendering aggregate 1705.

System Equivalence

The aggregation view FIG. 17 is functionally equivalent to all of our previously described systems and to any other systems of the same class. Adopting this model does not detract from the functionality of the systems described but rather can simplify analysis of the system's behavior.

Aggregation of FIG. 7 and FIG. 8

The graphical elements 705, 702, 703, 704, 707, 708 and 709 of FIG. 7 will be aggregated into the non-pixel rendering aggregate 1702. The graphical elements 706 and 710 will be aggregated into the pixel rendering aggregate 1703. The graphical elements 803, 804, 808 and 809 will be aggregated into the non-pixel rendering aggregate 1705. The graphical elements 806 and 810 will be aggregated into the pixel rendering aggregate 1706.

Aggregation of FIG. 10

The graphical elements 1002, 1003 and 1004 of FIG. 10 will be aggregated into the non-pixel rendering aggregate 1702. The graphical element 1005 will be aggregated into the pixel rendering aggregate 1703. The graphical elements 1006, 1007 and 1008 will be aggregated into the non-pixel rendering aggregate 1705. The graphical element 1009 will be aggregated into the pixel rendering aggregate 1706.

Aggregation of FIG. 11

The graphical elements 1102, 1103 and 1104 of FIG. 11 will be aggregated into the non-pixel rendering aggregate 1702. The graphical elements 1105 will be aggregated into the pixel rendering aggregate 1703. The graphical elements 1108 will be aggregated into the non-pixel rendering aggregate 1705. The graphical elements 1109 will be aggregated into the pixel rendering aggregate 1706.

Aggregation of FIG. 16

The graphical elements 1603 and 1604 of FIG. 16 will be aggregated into the non-pixel rendering aggregate 1702. The graphical elements 1605 will be aggregated into the pixel rendering aggregate 1703. The graphical elements 1610, and 1611 will be aggregated into the non-pixel rendering aggregate 1705. The graphical elements 1612 will be aggregated into the pixel rendering aggregate 1706.

TABLE 1
Remote Command: rend1_circle(0x1234, 1.0, 2.0, 3.0, 0x3)

| | Executed | |
|---|---|---|
| Command | Command | |
| in Render | on local | |
| Stream | client | Commands executed on the local client |
| 1 | 1 | rend1_circle(0x1234, 1.0, 2.0, 3.0, 0x3) |
| — | 2 | rend1_ellipse(0x1234, 1.0, 2.0, 3.0, 3.0, 0x3) |
| — | 3 | rend2_ellipse(0x1234, 1.0, 2.0, 3.0, 3.0, 0x3) |
| — | 4 | rend3_ellipse(0x1234, 1.0, 2.0, 3.0, 3.0, 0x3) |
| — | 5 | rend3_ellipse_internal(0x1234, 1.0, 2.0, |
| | | 3.0, 3.0, 0x3) |
| 2 | 6 | rend1_ellipse(0x1234, 1.0, 2.0, 3.0, 3.0, 0x3) |
| — | 7 | rend2_ellipse(0x1234, 1.0, 2.0, 3.0, 3.0, 0x3) |
| — | 8 | rend3_ellipse(0x1234, 1.0, 2.0, 3.0, 3.0, 0x3) |
| — | 9 | rend3_ellipse_internal(0x1234, 1.0, 2.0, |
| | | 3.0, 3.0, 0x3) |
| 3 | 10 | rend2_ellipse(0x1234, 1.0, 2.0, 3.0, 3.0, 0x3) |
| — | 11 | rend3_ellipse(0x1234, 1.0, 2.0, 3.0, 3.0, 0x3) |
| — | 12 | rend3_ellipse_internal(0x1234, 1.0, 2.0, |
| | | 3.0, 3.0, 0x3) |
| 4 | 13 | rend3_ellipse(0x1234, 1.0, 2.0, 3.0, 3.0, 0x3) |
| — | 14 | rend3_ellipse_internal(0x1234, 1.0, 2.0, |
| | | 3.0, 3.0, 0x3) |

LISTING 1

```
  1 #include <stdio.h>
  2 #include <sys/types.h>
  3 #include <sys/stat.h>
  4 #include <fcntl.h>
  5 #include <unistd.h>
  6 #include <stdlib.h>
  7
  8 typedef void * Surf;
  9 typedef unsigned int Color;
10
11 #define REND_GOOD 1
12
13 enum Args_type {
14  CIRCLE1_TYPE = 1,
15  ELLIPSE1_TYPE,
16  CIRCLE2_TYPE,
17  ELLIPSE2_TYPE,
18  CIRCLE3_TYPE,
19  ELLIPSE3_TYPE,
20 };
21
22 struct circle_args {
23  Surf surface;
24  float x;
25  float y;
26  float r;
27  Color color;
28 };
29
30 struct ellipse_args {
31  Surf surface;
32  float x;
33  float y;
34  float a;
35  float b;
36  Color color;
37 };
38
39 #include “internal.h”
40
41 int rend1_ellipse(Surf surface, float x, float y,
42 float a, float b, Color color);
43 int rend1_circle(Surf surface, float x, float y,
44 float r, Color color);
45 int rend2_ellipse(Surf surface, float x, float y,
46 float a, float b, Color color);
47 int rend2_circle(Surf surface, float x, float y,
48 float r, Color color);
49 int rend3_ellipse(Surf surface, float x, float y,
50 float a, float b, Color color);
51 int rend3_circle(Surf surface, float x, float y,
52 float r, Color color);
53
```

LISTING 2

```
  1 #include “render.h”
  2
  3 int rend1_ellipse(Surf surface, float x, float y,
```

float a, float b, Color color)

```
  4 {
  5  return(rend2_ellipse(surface, x, y, a, b, color));
  6 }
  7
  8 int rend1_circle(Surf surface, float x, float y,
```

float r, Color color)

9 {
10 return(rend1_ellipse(surface, x, y, r, r, color));
11 }
12
13 int rend2_ellipse(Surf surface, float x, float y,

float a, float b, Color color)

14 {
15 return(rend3_ellipse(surface, x, y, a, b, color));
16 }
17
18 int rend2_circle(Surf surface, float x, float y,

float r, Color color)

19 {
20 return(rend2_ellipse(surface, x, y, r, r, color));
21 }
22
23 int rend3_ellipse(Surf surface, float x, float y,

float a, float b, Color color)

24 {
25

return(rend3_ellipse_internal(surface, x, y, a, b, color));

26 }
27
28 int rend3_circle(Surf surface, float x, float y,

float r, Color color)

29 {
30 return(rend3_ellipse(surface, x, y, r, r, color));
31 }

LISTING 3

```
  1 #include “render.h”
  2
  3 void write_args(Args_type type, void *pargs) {
  4  send_over_link((void *) &type, sizeof type);
  5  switch(type){
  6  case(CIRCLE1_TYPE):
  7  send_over_link(pargs, sizeof (circle_args));
  8  break;
  9
  10  case(ELLIPSE1_TYPE):
  11  send_over_link(pargs, sizeof (ellipse_args));
  12  break;
  13
  14  case(CIRCLE2_TYPE):
  15  send_over_link(pargs, sizeof (circle_args));
  16  break;
  17
  18  case(ELLIPSE2_TYPE):
  19  send_over_link(pargs, sizeof (ellipse_args));
  20  break;
  21
  22  case(CIRCLE3_TYPE):
  23  send_over_link(pargs, sizeof (circle_args));
  24  break;
  25
  26  case(ELLIPSE3_TYPE):
  27  send_over_link(pargs, sizeof (ellipse_args));
  28  break;
  29
  30  default:
  31  fprintf(stderr, “Type %d unknown\n”, type);
  32  break;
  33  }
  34 }
  35
  36 int rend1_ellipse(Surf surface, float x, float y,
```

float a, float b, Color color)

```
  37 {
  38  ellipse_args ea;
  39  ea.surface= surface;
  40  ea.x= x;
  41  ea.y= y;
  42  ea.a= a;
  43  ea.b= b;
  44  ea.color= color;
  45  write_args(ELLIPSE1_TYPE, &ea);
  46  return(rend2_ellipse(surface, x, y, a, b, color));
  47 }
  48
  49 int rend1_circle(Surf surface, float x, float y,
```

float r, Color color)

```
  50 {
  51  circle_args ca;
  52  ca.surface= surface;
  53  ca.x= x;
  54  ca.y= y;
  55  ca.r= r;
  56  ca.color= color;
  57  write_args(CIRCLE1_TYPE, &ca);
  58  return(rend1_ellipse(surface, x, y, r, r, color));
  59 }
  60
  61 int rend2_ellipse(Surf surface, float x, float y,
```

float a, float b, Color color)

```
  62 {
  63  ellipse_args ea;
  64  ea.surface= surface;
  65  ea.x= x;
  66  ea.y= y;
  67  ea.a= a;
  68  ea.b= b;
  69  ea.color= color;
  70  write_args(ELLIPSE2_TYPE, &ea);
  71  return(rend3_ellipse(surface, x, y, a, b, color));
  72 }
  73
  74 int rend2_circle(Surf surface, float x, float y,
```

float r, Color color)

```
  75 {
  76  circle_args ca;
  77  ca.surface= surface;
  78  ca.x= x;
  79  ca.y= y;
  80  ca.r= r;
  81  ca.color= color;
  82  write_args(CIRCLE2_TYPE, &ca);
  83  return(rend2_ellipse(surface, x, y, r, r, color));
  84 }
  85
  86 int rend3_ellipse(Surf surface, float x, float y,
```

float a, float b, Color color)

```
  87 {
  88  ellipse_args ea;
  89  ea.surface= surface;
  90  ea.x= x;
  91  ea.y= y;
  92  ea.a= a;
  93  ea.b= b;
  94  ea.color= color;
  95  write_args(ELLIPSE3_TYPE, &ea);
  96  return(rend3_ellipse_internal(surface, x, y,
```

a, b, color));

```
  97 }
  98
  99 int rend3_circle(Surf surface, float x, float y,
```

float r, Color color)

100 {
101 circle_args ca;
102 ca.surface= surface;
103 ca.x= x;
104 ca.y= y;
105 ca.r= r;
106 ca.color= color;
107 write_args(CIRCLE3_TYPE, &ca);
108 return(rend3_ellipse(surface, x, y, r, r, color));
109 }

LISTING 4

| | |
|---|---|
| 1 | #include “render.h” |
| 2 | |
| 3 | int main(int argc, char *argv[ ]) |
| 4 | { |
| 5 | Args_type type; |
| 6 | |
| 7 | while(type= read_type( )) { |
| 8 | switch(type) { |
| 9 | case(CIRCLE1_TYPE): |
| 10 | { |
| 11 | circle_args ca; |
| 12 | read_args(&ca, sizeof ca); |
| 13 | rend1_circle(ca.surface, ca.x, ca.y, ca.r, ca.color); |
| 14 | } |
| 15 | break; |
| 16 | |
| 17 | case(ELLIPSE1_TYPE): |
| 18 | { |
| 19 | ellipse_args ea; |
| 20 | read_args(&ea, sizeof ea); |
| 21 | rend1_ellipse(ea.surface, ea.x, ea.y, |

ea.a, ea.b, ea.color);

| | |
|---|---|
| 22 | } |
| 23 | break; |
| 24 | |
| 25 | case(CIRCLE2_TYPE): |
| 26 | { |
| 27 | circle_args ca; |
| 28 | read_args(&ca, sizeof ca); |
| 29 | rend2_circle(ca.surface, ca.x, ca.y, ca.r, ca.color); |
| 30 | } |
| 31 | break; |
| 32 | |
| 33 | case(ELLIPSE2_TYPE): |
| 34 | { |
| 35 | ellipse_args ea; |
| 36 | read_args(&ea, sizeof ea); |
| 37 | rend2_ellipse(ea.surface, ea.x, ea.y, |

ea.a, ea.b, ea.color);

| | |
|---|---|
| 38 | } |
| 39 | break; |
| 40 | |
| 41 | case(CIRCLE3_TYPE): |
| 42 | { |
| 43 | circle_args ca; |
| 44 | read_args(&ca, sizeof ca); |
| 45 | rend3_circle(ca.surface, ca.x, ca.y, ca.r, ca.color); |
| 46 | } |
| 47 | break; |
| 48 | |
| 49 | case(ELLIPSE3_TYPE): |
| 50 | { |
| 51 | ellipse_args ea; |
| 52 | read_args(&ea, sizeof ea); |
| 53 | rend3_ellipse(ea.surface, ea.x, ea.y, |

ea.a, ea.b, ea.color);

| | |
|---|---|
| 54 | } |
| 55 | break; |
| 56 | |
| 57 | default: |
| 58 | fprintf(stderr, “Type %d unknown\n”, type); |
| 59 | return(1); |
| 60 | } |
| 61 | } |
| 62 | } |
| 63 | |

LISTING 5

| | |
|---|---|
| 1 | #include “render.h” |
| 2 | |
| 3 | int rend1_mask; |
| 4 | int rend2_mask; |
| 5 | int rend3_mask; |
| 6 | |
| 7 | void write_args(Args_type type, void *pargs) { |
| 8 | send_over_link((void *) &type, sizeof type); |
| 9 | switch(type){ |
| 10 | case(CIRCLE1_TYPE): |
| 11 | send_over_link(pargs, sizeof (circle_args)); |
| 12 | break; |
| 13 | |
| 14 | case(ELLIPSE1_TYPE): |
| 15 | send_over_link(pargs, sizeof (ellipse_args)); |
| 16 | break; |
| 17 | |
| 18 | case(CIRCLE2_TYPE): |
| 19 | send_over_link(pargs, sizeof (circle_args)); |
| 20 | break; |
| 21 | |
| 22 | case(ELLIPSE2_TYPE): |
| 23 | send_over_link(pargs, sizeof (ellipse_args)); |
| 24 | break; |
| 25 | |
| 26 | case(CIRCLE3_TYPE): |
| 27 | send_over_link(pargs, sizeof (circle_args)); |
| 28 | break; |
| 29 | |
| 30 | case(ELLIPSE3_TYPE): |
| 31 | send_over_link(pargs, sizeof (ellipse_args)); |
| 32 | break; |
| 33 | |
| 34 | default: |
| 35 | fprintf(stderr, “Type %d unknown\n”, type); |
| 36 | break; |
| 37 | } |
| 38 | } |
| 39 | |
| 40 | int rend1_ellipse(Surf surface, float x, float y, |

float a, float b, Color color)

| | |
|---|---|
| 41 | { |
| 42 | if(rend1_mask++ == 0) { |
| 43 | ellipse_args ea; |
| 44 | ea.surface= surface; |
| 45 | ea.x= x; |
| 46 | ea.y= y; |
| 47 | ea.a= a; |
| 48 | ea.b= b; |
| 49 | ea.color= color; |
| 50 | write_args(ELLIPSE1_TYPE, &ea); |
| 51 | } |
| 52 | int ret= rend2_ellipse(surface, x, y, a, b, color); |
| 53 | rend1_mask−−; |
| 54 | return(ret); |
| 55 | } |
| 56 | |
| 57 | int rend1_circle(Surf surface, float x, float y, float r, Color color) |
| 58 | { |
| 59 | if(rend1_mask++ == 0) { |
| 60 | circle_args ca; |
| 61 | ca.surface= surface; |
| 62 | ca.x= x; |
| 63 | ca.y= y; |
| 64 | ca.r= r; |
| 65 | ca.color= color; |
| 66 | write_args(CIRCLE1_TYPE, &ca); |
| 67 | } |
| 68 | int ret= rend1_ellipse(surface, x, y, r, r, color); |
| 69 | rend1_mask−−; |
| 70 | return(ret); |
| 71 | } |
| 72 | |
| 73 | int rend2_ellipse(Surf surface, float x, float y, float a, |
| | float b, Color [symbol] |
| 74 | { |
| 75 | if(rend2_mask++ == 0 && rend1_mask == 0) { |
| 76 | ellipse_args ea; |
| 77 | ea.surface= surface; |
| 78 | ea.x= x; |
| 79 | ea.y= y; |
| 80 | ea.a= a; |
| 81 | ea.b= b; |
| 82 | ea.color= color; |
| 83 | write_args(ELLIPSE2_TYPE, &ea); |
| 84 | } |
| 85 | int ret= rend3_ellipse(surface, x, y, a, b, color); |
| 86 | rend2_mask−−; |
| 87 | return(ret); |
| 88 | } |
| 89 | |
| 90 | int rend2_circle(Surf surface, float x, float y, float r, Color color) |
| 91 | { |
| 92 | if(rend2_mask++ == 0 && rend1_mask == 0) { |
| 93 | circle_args ca; |
| 94 | ca.surface= surface; |
| 95 | ca.x= x; |
| 96 | ca.y= y; |
| 97 | ca.r= r; |
| 98 | ca.color= color; |
| 99 | write_args(CIRCLE2_TYPE, &ca); |
| 100 | } |
| 101 | int ret= rend2_ellipse(surface, x, y, r, r, color); |
| 102 | rend2_mask−−; |
| 103 | return(ret); |
| 104 | } |
| 105 | |
| 106 | int rend3_ellipse(Surf surface, float x, float y, float a, |
| | float b, Color c [symbol] |
| 107 | { |
| 108 | if(rend3_mask++ == 0 && rend1_mask == 0 && |
| | rend2_mask == 0) { |
| 109 | ellipse_args ea; |
| 110 | ea.surface= surface; |
| 111 | ea.x= x; |
| 112 | ea.y= y; |
| 113 | ea.a= a; |
| 114 | ea.b= b; |
| 115 | ea.color= color; |
| 116 | write_args(ELLIPSE3_TYPE, &ea); |
| 117 | } |
| 118 | int ret= rend3_ellipse_internal(surface, x, y, a, b, color); |
| 119 | rend3_mask−−; |
| 120 | return(ret); |
| 121 | } |
| 122 | |
| 123 | int rend3_circle(Surf surface, float x, float y, float r, Color color) |
| 124 | { |
| 125 | if(rend3_mask++ == 0 && rend1_mask == 0 && |
| | rend2_mask == 0) { |
| 126 | circle_args ca; |
| 127 | ca.surface= surface; |
| 128 | ca.x= x; |
| 129 | ca.y= y; |
| 130 | ca.r= r; |
| 131 | ca.color= color; |
| 132 | write_args(CIRCLE3_TYPE, &ca); |
| 133 | } |
| 134 | int ret= rend3_ellipse(surface, x, y, r, r, color); |
| 135 | rend3_mask−−; |
| 136 | return(ret); |
| 137 | } |

[symbol]

indicates data missing or illegible when filed

What is claimed is:

1. A system for remote graphics using a distributed graphics stack, comprising:
a remote computing device, comprising a first processor, and running a first operating system, comprising:
an application that is executed by said first processor;
a remote non-pixel rendering aggregate coupled to said application for generating rendering procedure calls;
a remote non-pixel extension stub coupled with said remote non-pixel rendering aggregate for assembling said rendering procedure calls into a data stream;
a data channel for transporting data; and
a transmitter coupled with said remote non-pixel extension stub for transmitting said data stream on said data channel;
and
a local computing device, comprising a second processor, and running a second operating system, comprising:
a local display for displaying composed graphics;
a local pixel buffer for rendering graphics;
a receiver for receiving said data stream from said data channel;
a local non-pixel extension stub coupled with said receiver for disassembling said rendering procedure calls from said data stream;
a local non-pixel rendering aggregate coupled with said local non-pixel extension stub for executing said rendering procedure calls;
a local pixel rendering aggregate coupled with said local non-pixel rendering aggregate for rendering on said local pixel buffer; and
a local surface composer coupled with said local pixel rendering aggregate for composing graphics from said local pixel buffer on said local display.

2. The system of claim 1, further including:
a remote pixel rendering aggregate on said remote computing device, coupled to said remote non-pixel rendering aggregate bypassing rendering of a remote pixel image by said first processor.

3. The system of claim 1, further including:
a remote display for displaying composed graphics on said remote computing device;
a remote pixel buffer for rendering graphics on said remote computing device;
a remote pixel rendering aggregate on said remote computing device, coupled to said remote non-pixel rendering aggregate for rendering on said remote pixel buffer; and
a remote surface composer on said remote computing device, coupled with said remote pixel rendering aggregate for composing graphics from said second pixel buffer on said second display.

4. The system of claim 1 wherein:
said remote non-pixel rendering aggregate, comprising:
a plurality of coupled remote non-pixel rendering elements;
one or more remote non-pixel rendering elements extension stubs coupled to a subset of said remote non-pixel rendering elements; and
a remote non-pixel rendering aggregate multiplexer comprising:
one or more remote non-pixel rendering aggregate multiplexer inputs coupled to said remote non-pixel rendering elements extension stubs; and
a remote non-pixel rendering aggregate multiplexer output is coupled to said remote non-pixel extension stub;
and
said local non-pixel rendering aggregate, comprising:
a plurality of coupled local non-pixel rendering elements;
one or more local non-pixel rendering elements extension stubs coupled to a subset of said local non-pixel rendering elements; and
a local non-pixel rendering aggregate demultiplexer comprising:
one or more local non-pixel rendering aggregate demultiplexer inputs coupled to said local non-pixel rendering elements extension stubs; and
a local non-pixel rendering aggregate multiplexer input is coupled to said local non-pixel extension stub.

5. The system of claim 4, further including:
a remote pixel rendering aggregate on said remote computing device, coupled to said remote non-pixel rendering aggregate bypassing rendering of a remote pixel image by said first processor.

6. The system of claim 4, further including:
a remote display for displaying composed graphics on said remote computing device;
a remote pixel buffer for rendering graphics on said remote computing device;
a remote pixel rendering aggregate on said remote computing device, coupled to said remote non-pixel rendering aggregate for rendering on said remote pixel buffer; and
a remote surface composer on said remote computing device, coupled with said remote pixel rendering aggregate for composing graphics from said second pixel buffer on said second display.

7. A method for remote graphics using a distributed graphics system comprising:
running, by a remote computing device, an application;
compiling, by a non-pixel rendering aggregate on the remote computing device, a plurality of rendering procedure calls;
executing, by the non-pixel rendering aggregate on the remote computing device, the rendering procedure calls;
returning, by the non-pixel rendering aggregate, values to the calling application;
assembling, by a remote stub on the remote computing device, a plurality of rendering procedure calls into a data stream;
transmitting, by the remote stub on the remote computing device, the data stream to a local computing device;
disassembling, by a local stub on the local computing device, the data stream into a plurality of local rendering procedure calls;
executing, by a local non-pixel rendering aggregate on the local computing device, the local rendering procedure calls;
calling, by the local non-pixel rendering aggregate on the local computing device, rendering routines of a local pixel rendering aggregate;
rendering, by the local pixel rendering aggregate on the local computing device, pixels to generate rendered graphics; and
composing the rendered graphics on a display of the local computing device.
